(19) United States
(12) Patent Application Publication
(10) Pub. No.: US 2010/0270333 A1
(43) Pub. Date: Oct. 28, 2010

(54) POWDER CONTAINER CAPABLE OF CONTROLLING AMOUNT OF DISCHARGED POWDER

(75) Inventor: Jae-Sung ROH, Bucheon-City (KR)

Correspondence Address: CANTOR COLBURN, LLP, 20 Church Street, 22nd Floor, Hartford, CT, 06103, US

(73) Assignee: SHINYOUNG CO., LTD, Incheon-City (KR)

(21) Appl. No.: 12/630,517

(22) Filed: Dec. 3, 2009

(30) Foreign Application Priority Data
Apr. 24, 2009 (KR) 10-2009-0035897

(51) Int. Cl. B67D 7/58

(52) U.S. Cl. 222/167; 222/410; 222/168; 222/205

(57) ABSTRACT

A powder container capable of controlling the amount of discharged powder, which is provided with a rotatable powder supply unit capable of being rotated to discharge powder from the container to the outside, thus allowing a user to easily control the amount of discharged powder while viewing the powder discharged from the container with the eyes, is disclosed. The powder container includes a housing containing powder therein, a cap hinged to the housing and opening or closing the opening of the housing, a discharge plate provided in the housing and having a discharge hole for discharging powder, a rotatable powder supply unit provided in the housing and being rotated to supply powder from the housing to the discharge hole of the discharge plate, and a rotation guide unit for guiding the rotation of the powder supply unit.

### BACKGROUND OF THE INVENTION

1. Technical Field

The present invention relates generally to powder containers for containing therein powdered contents, such as powdered cosmetics or powdered seasonings and, more particularly, to a powder container capable of controlling the amount of powder discharged, which is provided with a rotatable powder supply unit capable of rotating to discharge to the outside the powder of the container, thus allowing a user to easily control the amount of powder discharged while viewing the powder being discharged from the container with the eyes.

2. Description of the Related Art

Cosmetics are typically classified into several different types, that is, liquid cosmetics, such as lotions, plus solid cosmetics used with sponges, and powdered cosmetics used by being sprayed onto the skin little by little or by being applied to the skin with puffs.

Among conventional containers for the several different types of cosmetics, a container for the powdered cosmetics is configured such that a middle plate having powder discharge holes of a small size is placed in the container, with a puff placed on the middle plate and used for applying powder, discharged from the container through the powder discharge holes of the middle plate, to the skin of a user.

To use cosmetic powder contained in the container, the user knocks the container on the bottom while holding the container turned upside down with the puff closing the powder discharge holes. Thus, the powder is discharged from the container to the puff through the powder discharge holes and the user can apply the powder to the skin using the puff.

The above-mentioned powder container is advantageous in that it has a simple structure. However, the container is problematic in that a user cannot easily or desirably control the amount of discharged powder. To control the amount of discharged powder, the user must control the knocking strength or the number of times the bottom of the container is knocked. Thus, the container is inconvenient to the user.

Further, when the cap of the container is opened, the powder pressurized by knocking on the bottom of the container comes out and makes the surroundings messy.

In an effort to overcome these problems, a method of pumping powder to supply the powder to the powder discharge holes instead of the method of knocking the container has been proposed.

Examples of conventional cosmetic powder containers using the pumping method can be seen in Korean Patent No. 10-647455 registered on Nov. 13, 2006 and entitled “Cosmetics container for containing cosmetics”, Korean U.M. Registration No. 20-0424791 registered on Aug. 21, 2006 and entitled “Structure for dispending powder in a cosmetic container, Korean U.M. Registration No. 20-0430573 registered on Nov. 1, 2006 and entitled “Pumping structure for powder”, and Korean U.M. Registration No. 20-0402608 registered on Nov. 28, 2005 and entitled “A powder case possible of controlling discharge quantity”.

Each of the above-mentioned conventional techniques is configured to discharge the powder of a container using a pumping method and is advantageous in that it is easy to use the container when compared to the containers configured to discharge powder by the knocking method. Another advantage of the techniques using the pumping method resides in that a user can control the amount of powder discharged even though the control is not so precise.

However, when compared to a technique proposed by the present invention, the pumping method of the above-mentioned conventional techniques cannot realize the precise control of discharged powder as is desired by a user.

Another problem of the pumping method of the conventional techniques is that in order to prevent powder from being stirred up, a user must pump the powder in a state in which the cap of the container is closed.

Further, the pumping method of the conventional techniques must be executed in a state in which the cap of the container is closed, so that the user, when discharging powder, cannot confirm the amount of powder which is discharged with the eyes.

An example of conventional containers for containing powdered contents, which are not limited to powdered cosmetics, can be found in Korean U.M. Registration No. 20-0235199 registered on Jun. 11, 2001 and entitled “Powder discharging device”.

Korean U.M. Registration No. 20-0235199 discloses a device for discharging powdered contents, such as powdered milk, powdered red pepper, sugar or salt. The powder discharging device includes a rotatable control ball, which has alternating spaces and closers and is installed using a hinge shaft in a housing tightened to the mouth of a container so as to be rotatable. Outside of the housing, a control knob mounted to an end of the hinge shaft is manipulated by a user to controllably rotate the control ball. Thus, the powder discharging device can be controlled so as to discharge a desired amount of powder from the container.

The powder discharging device of 20-0235199 can control the amount of discharged powder using a rotating method, so that the concept of the device relates to the concept of the present invention.

However, the construction and operational effects of the powder discharging device of 20-0235199 are different from those of the present invention.

### SUMMARY OF THE INVENTION

Accordingly, the present invention has been made keeping in mind the above problems occurring in the prior art, and is intended is to provide a powder container, which can discharge powder with a rotating method unlike the conventional containers having a pumping structure, so that the container of the present invention can easily control the amount of discharged powder and can realize a precise powder discharging operation.

Further, the present invention is intended to provide a powder container, which can discharge powder using a rotating method instead of the conventional knocking or pumping method, so that the present invention can solve the problem of the powder undesirably coming out and making the surroundings messy when the powder is being discharged from the container.

Further, the present invention is intended to provide a powder container, which allows a user to discharge a desired amount of powder while viewing the amount of discharged powder with the eyes without turning the container upside down.

In order to accomplish the above objects, the present invention provides a powder container, comprising a housing containing powder therein, a cap hinged to the housing and opening or closing an opening of the housing, a discharge plate provided in the housing and having a discharge hole for discharging powder, a rotatable powder supply unit provided in the housing and supplying powder from the housing to the discharge hole of the discharge plate through rotation, and a rotation guide unit for guiding the rotation of the powder supply unit.

Further, the rotatable powder supply unit of the present invention may comprise a rotary shaft coupled to the rotation guide unit and a powder supply part connected to the rotary shaft and arranged in radial directions around the rotary shaft, wherein the powder supply part may comprise a head for accepting powder in the housing and supplying the powder to the discharge hole, and a connection rib connecting the head to the rotary shaft, wherein the head may be inclined so that the powder can be easily supplied.

The present invention provides the following advantages.

When a user rotates the rotation guide unit, the rotatable powder supply unit coupled to the rotation guide unit is rotated and discharges the powder from the container to the outside.

Further, the powder container can efficiently discharge the powder without being turned upside down or actuating a pumping structure, so that it is not necessary to turn the container upside down when discharging powder.

Thus, the user can discharge a desired amount of powder while viewing the amount of discharged powder with the eyes.

Further, when the powder is discharged from the powder container of the present invention, the powder does not undesirably come out, thus freeing the user from making the surroundings messy.

Finally, the powder container of the present invention can realize easy and precise control of the amount of discharged powder, thus being convenient to users.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a powder container according to an embodiment of the present invention when a cap of the container is opened;

FIG. 2 is an exploded perspective view of the powder container according to the present invention;

FIG. 3 is a sectional view of the powder container according to the present invention; and

FIG. 4 is a sectional view showing the operation of the powder container according to the present invention.

### DESCRIPTION OF THE PREFERRED EMBODIMENTS

Hereinbelow, the powder container of the present invention will be described in detail with reference to the accompanying drawings.

In the following description, for ease of description, the container of the present invention is limited to a cosmetics container containing powdered cosmetics. However, it should be understood that the present invention is not limited to a cosmetics container containing cosmetics, but is adapted to containers containing powdered contents therein. Further, the term “powder” used in the following description means a powdered material.

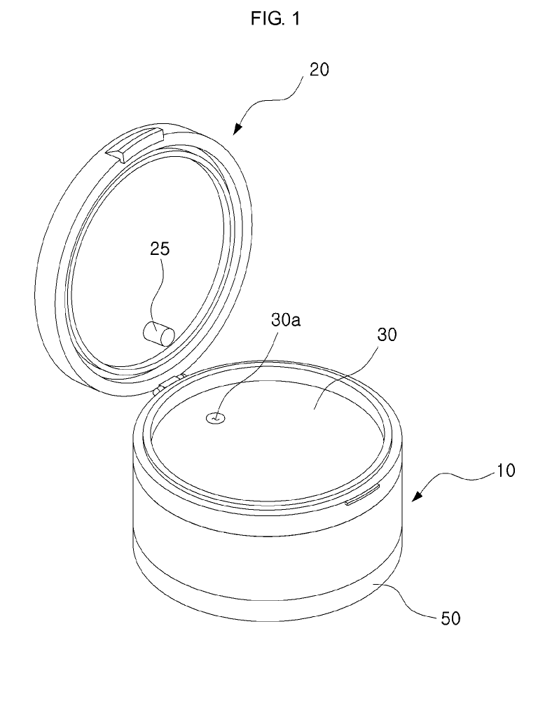

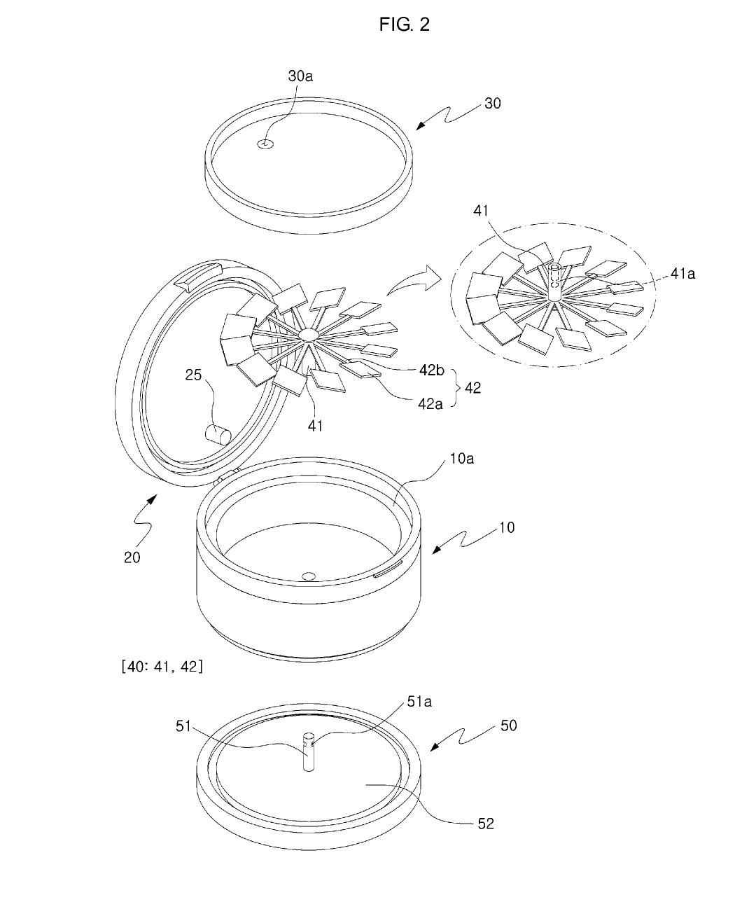

As shown in FIG. 1 and FIG. 2, the powder container of the present invention, that is, the powdered cosmetics container comprises a housing 10 containing powder therein and a cap 20 hinged to the housing 10 so as to open or close the opening of the housing. The housing 10 and the cap 20 form the appearance of the container.

The container further comprises a discharge plate 30, which is provided in the housing 10 and has a discharge hole 30a for discharging powder, and a rotatable powder supply unit 40, which is provided in the housing 10 and feeds the powder to the discharge hole 30a of the discharge plate 30 because of rotation thereof.

Further, a rotation guide unit 50 is rotatably mounted to the lower surface of the housing 10 and is coupled to the rotatable powder supply unit 40 so as to guide rotation of the rotatable powder supply unit 40.

Described in detail, the discharge plate 30 is seated on a step 10a formed around the inner surface of the housing 10 and has a flat, shallow receptacle shape having a sidewall and a bottom wall. Because the discharge plate 30 has a structure wherein it is seated on the step 10a of the housing 30, a user can easily remove or install the discharge plate 30 from or into the housing 10.

In the embodiment, the discharge hole 30a formed in the discharge plate 30 so as to discharge powder protrudes downwards from the lower surface of the discharge plate 30.

In the present invention, the discharge hole may be embodied as a flat hole formed though the discharge plate 30 without protruding or as a hole protruding upwards from the upper surface of the discharge plate 30. When viewed in terms of operational efficiency, it is preferred that the discharge hole 30a protrude downwards from the lower surface of the discharge plate 30.

The downward protruding structure of the discharge hole 30a is advantageous because the powder bucketed by the rotatable powder supply unit 40 can be easily fed to the discharge hole 30a.

The downward protruding structure of the discharge hole 30a has the further advantage of it being able to define a puff seat on the upper surface of the discharge plate 30, so that, when the cap 20 of the housing 10 is closed after a user applies the discharged powder to the skin with the puff, the puff can be seated in the puff seat of the discharge plate 30.

Further, when a user carries the container with the puff not placed on the discharge plate 30 having the discharge hole, but carried separately from the container, the puff cannot close the discharge hole, so that the powder may be freely moved through the discharge hole 30a. In an effort to solve this problem, the container of the present invention further includes a plug 25, which protrudes downwards from the lower surface of the cap 20 so as to close the discharge hole 30a.

Because the plug 25 functioning to close the discharge hole 30a protrudes downwards from the lower surface of the cap as described above, the discharge hole 30a preferably protrudes downwards from the lower surface of the discharge plate 30 so as to realize easy and precise insertion of the plug 25 into the discharge hole 30a. Thus, in the present invention, it is preferred that the discharge hole 30a protrude downwards from the lower surface of the discharge plate 30.

In the description below, the rotatable powder supply unit 40 and the rotation guide unit 50 coupled to the powder supply unit so as to guide the rotation of the powder supply unit 40, which are characteristic parts of the present invention, will be described.

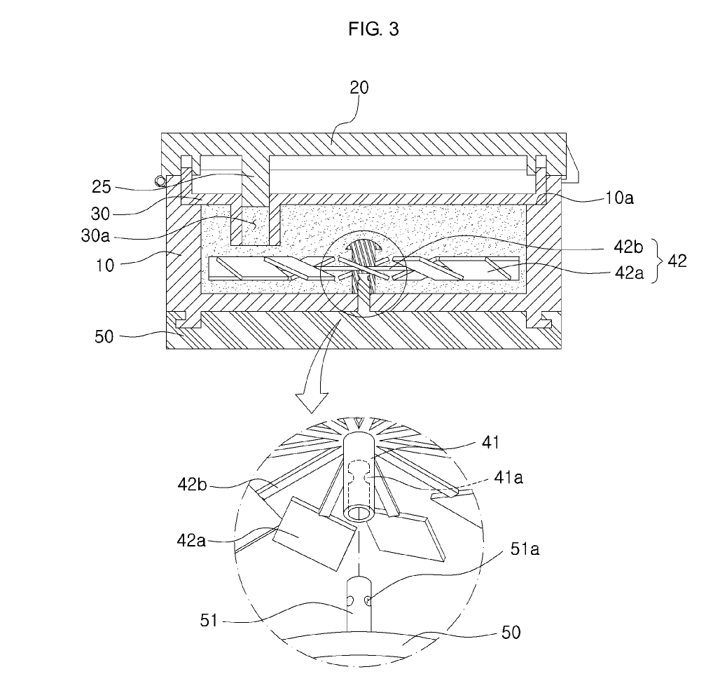

With reference to FIG. 2 and FIG. 3, the rotatable powder supply unit 40 comprises a rotary shaft 41 and a plurality of powder supply parts 42, which are arranged around the rotary shaft 41 in radial directions.

Each of the powder supply parts 42 comprises a head 42a, which buckets the powder in the housing 10 and feeds the powder to the discharge hole 30a, and a connection rib 42b connecting the head 42a to the rotary shaft 41.

The rotary shaft 41 is coupled to the rotation guide unit 50.

Thus, when the user rotates the rotation guide unit 50, the rotary shaft 41 coupled to the rotation guide unit 50 rotates, so that the heads 42a rotate. During the rotation, the heads 42a bucket the powder in the container 10 and feed the powder to the discharge hole 30a. Therefore, the powder can be discharged upwards to the upper surface of the discharge plate 30 through the discharge hole 30a.

The head 42a has a surface area capable of loading the powder thereon. In the embodiment shown in FIG. 2 and FIG. 3, the head 42a of the present invention has a rectangular shape.

Further, the rectangular head 42a is not parallel to the bottom of the container inclined, but is inclined relative to the bottom of the container. The inclined structure of the heads 42a realizes easy bucketing of the powder and easy feeding of the powder to the discharge hole during rotation of the heads 42a.

In the present invention, it is preferred that the head 42a have a bucket shape which is concaved downwards so as to easily and efficiently bucket the powder. The bucket-shaped head is not shown in the drawings.

Fitting is how the rotation guide unit 50 and the rotary shaft 41 are coupled. The fitting structure provided between the rotation guide unit 50 and the rotary shaft 41 may be selected from several structures.

One example of the fitting structure, which may be adapted to the coupling of the rotation guide unit 50 and the rotary shaft 41, is shown in FIG. 2 and FIG. 3.

As shown in FIGS. 2 and 3, the lower end of the rotary shaft 41, to the upper end of which the connection ribs 42b are connected in radial directions, is axially hollowed, thus forming a shaft hole, and locking protrusions 41a are formed around the inner surface of the shaft hole of the rotary shaft 41. The rotation guide unit 50 is locked to the locking protrusions 41a.

The rotation guide unit 50 comprises a locking shaft 51, which has locking slots 51a around the outer circumferential surface thereof so as to engage with the locking protrusions 41a, and a base plate 52, which is connected to the locking shaft 51 and is placed below the lower surface of the housing 10.

To couple the rotatable powder supply unit 40 to the rotation guide unit 50 using fitting, the locking protrusions 41a formed around the inner surface of the rotary shaft 41 of the rotatable powder supply unit 40 are forcibly inserted into respective locking slots 51a formed in the outer circumferential surface of the locking shaft 51 of the rotation guide unit 50.

Through the fitting, the rotatable powder supply unit 40 is locked to the rotation guide unit 50. Thus, when the rotation guide unit 50 is rotated, the rotatable powder supply unit 40 can be rotated without idle-rotating.

In the present invention, it should be understood that the coupling structure for coupling the rotatable powder supply unit 40 to the rotation guide unit 50 may be variously altered without being limited to the fitting structure shown in FIG. 2 and FIG. 3.

As described above, the lower surface of the cap 20 hinged to the housing 10 is provided with the plug 25, so that, when the user closes the cap 20 of the housing 10 after applying the powder to the skin with the puff, the plug 25 can close the discharge hole 30a of the discharge plate 30.

In the present invention, the plug 25 may be configured such that it can be inserted into the discharge hole 30a or can simply close the discharge hole 30a without being inserted into the hole 30a.

When the plug 25 is configured such that it can be inserted into the discharge hole 30a, it is preferred that the discharge hole 30a protrude downwards from the lower surface of the discharge plate 30 as described above.

Thus, when it is required to use the powder of the container according to the present invention, it is not necessary for a user to turn the container upside down after closing the cap 20 and to knock the bottom of the container or to pump the powder.

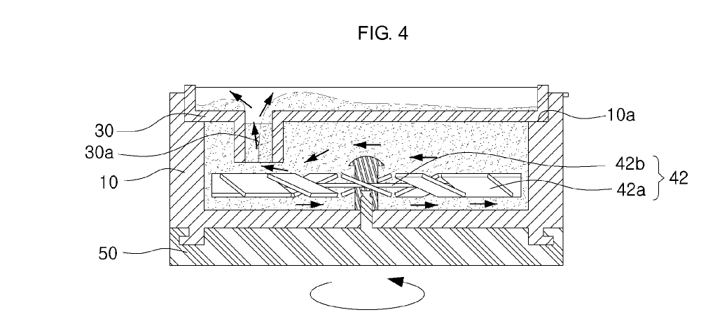

But, as shown in FIG. 1 and FIG. 4, the user opens the cap 20 and rotates the rotation guide unit 50 rotatably placed below the housing 10. Thus, the rotatable powder supply unit 40 locked to the rotation guide unit 50 is rotated and the heads 42a of the rotatable powder supply unit 40 bucket the powder in the housing 10 and feed the powder to the discharge hole 30a, thus discharging the powder to the upper surface of the discharge plate 30 through the discharge hole 30a.

The above-mentioned process is executed by the user, who opens the cap 20 and can view the discharge of powder with the eyes when performing the process, so that the user can easily discharge the desired amount of powder.

Although a preferred embodiment of the powder container according to the present invention has been described for illustrative purposes, those skilled in the art will appreciate that various modifications, additions and substitutions are possible, without departing from the scope and spirit of the invention as disclosed in the accompanying claims.

What is claimed is:

1. A powder container capable of controlling the amount of discharged powder, comprising:
a housing containing powder therein;
a cap hinged to the housing and opening or closing an opening of the housing;
a discharge plate provided in the housing and having a discharge hole for discharging powder;
a rotatable powder supply unit provided in the housing and which is rotated to supply the powder in the housing to the discharge hole of the discharge plate; and
a rotation guide unit for guiding the rotation of the powder supply unit,
wherein the rotatable powder supply unit comprises a rotary shaft coupled to the rotation guide unit and a powder supply part connected to the rotary shaft and arranged in radial directions around the rotary shaft.

2. The powder container capable of controlling the amount of discharged powder according to claim 1, wherein the powder supply part comprises:
a head for taking powder in the housing and supplying the powder to the discharge hole; and
a connection rib connecting the head to the rotary shaft,
wherein the head is inclined so as to realize easy supply of the powder.

3. The powder container according to claim 1, wherein the cap is provided with a plug on a lower surface thereof which closes the discharge hole of the discharge plate.

4. The powder container according to claim 2, wherein the cap is provided with a plug on a lower surface thereof which closes the discharge hole of the discharge plate.
